(19) United States
(12) Patent Application Publication
(10) Pub. No.: US 2008/0013472 A1
(43) Pub. Date: Jan. 17, 2008

(54) Method of controlling data broadcast and data broadcast receiver

(76) Inventor: Jin Wook Kwon, Seoul (KR)

Correspondence Address: Song K. Jung;MCKENNA LONG & ALDRIDGE LLP, 1900 K Street, N.W., Washington, DC, 20006, US

(21) Appl. No.: 11/826,345

(22) Filed: Jul. 13, 2007

(30) Foreign Application Priority Data
Jul. 14, 2006 (KR) 10-2006-0066146

(51) Int. Cl. H04J 15/00

(52) U.S. Cl. 370/312; 370/390

(57) ABSTRACT

A method of controlling a data broadcast application and broadcast receiver processing the same are disclosed, by which hardware can be expanded without additional cost during a compression storage system to store a data broadcast application in a memory. The present invention includes a signal receiving unit receiving a data broadcast signal including an application supported by a data broadcasting platform, a data decoder decoding the data broadcast signal, a storage unit for storing the application decoded by the data decoder and a control means for controlling a storage system of the storage unit according to a signal for selecting the storage system of the storage unit, the control means controlling an execution of the application.

This application claims the benefit of the Korean Patent Application No. 10-2006-0066146, filed on Jul. 14, 2006, which is hereby incorporated by reference as if fully set forth herein.

### BACKGROUND

1. Field

The present disclosure relates to a method of controlling a data broadcast and data broadcast receiver, and more particularly, to a method of controlling a data broadcast application and broadcast receiver processing the same.

2. Discussion of the Related Art

Generally, a broadcasting station or the like transmits video and audio signals. Owing to the rapid developments of digital broadcasting, the broadcasting station or the like recently transmits various data broadcast signals independently or together with video and audio signals.

There are various kinds of data broadcasting such as OCAP (Open Cable Application Platform) data broadcasting, MHP (Multimedia Home Platform) data broadcasting, ACAP (Advanced Common Application Platform) data broadcasting, and the like for example.

However, in storing a data broadcast application, if a size of the application is considerably large, limitation is put on a memory size of a receiver.

Moreover, in case of increasing a system speed, it may frequently happen that a storage system should be changed.

### SUMMARY

Accordingly, the present invention is directed to a method of controlling a data broadcast application and broadcast receiver processing the same that substantially obviate one or more problems due to limitations and disadvantages of the related art.

An object of the present invention is to provide a method of controlling a data broadcast application and broadcast receiver processing the same, by which hardware can be expanded without additional cost using a compression storage system to store a data broadcast application in a memory.

Another object of the present invention is to provide a method of controlling a data broadcast application and broadcast receiver processing the same, by which a storage system can be switched to a non-compression system to execute an application faster using a compression storage system in case that a speed is reduced.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a broadcast receiver according to the present invention includes a signal receiving unit receiving a data broadcast signal including an application supported by a data broadcasting platform, a data decoder decoding the data broadcast signal, a storage unit for storing the application decoded by the data decoder and a control means for controlling a storage system of the storage unit according to a signal for selecting the storage system of the storage unit, the control means controlling an execution of the application.

In another aspect of the present invention, a method of controlling a data broadcast application includes receiving a storage system selection signal, switching a storage system according to the storage system selection signal, and storing a received application supported by a data broadcasting platform by the switched storage system.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the implementations and are incorporated in and constitute a part of this disclosure, illustrate implementations and together with the description serve to explain the implementations. In the drawings;

FIG. 1 is a block diagram of a broadcast receiver capable of receiving a data broadcast application according to one embodiment of the present invention;

FIG. 2 is a block diagram of a control means of a broadcast receiver for storing a data broadcast application according to the present invention;

FIG. 3 is a diagram to explain a broadcast signal received by being segmented;

FIG. 4 is a schematic flowchart of a method of controlling a data broadcast application according to the present invention;

FIG. 5 is a detailed flowchart of a method of controlling a data broadcast application according to one embodiment of the present invention;

FIG. 6A and FIG. 6B are diagrams of OSD for enabling external inputs; and

FIG. 7 is a whole broadcast system according to the present invention.

### DETAILED DESCRIPTION OF THE INVENTION

Reference will now be made in detail to the implementations, examples of which are illustrated in the accompanying drawings. Wherever possible, the same reference numbers will be used throughout the drawings to refer to the same or like parts.

First of all, in transmitting a data broadcast, a data broadcast transmitting terminal provides a bound application, an unbound application and the like to a broadcast receiver.

In particular, the bound application is an application associated with A/V streams and means an application that is not usable by a user in case of tuning a currently viewed specific channel to another channel. The bound application is the application associated with an A/V stream of a channel currently selected by a tuner. The bound application is displayed in a manner that signals are continuously received from a broadcasting station. Since the bound application is stored in a temporary storage unit instead of being permanently or semi-permanently stored in a broadcast receiver, it is deleted in case of tuning a specific channel into another channel.

On the other hand, the unbound application is an application not associated with a specific A/V channel. The unbound application means an application usable by a user if a currently viewed specific channel is tuned to another channel or even if a power of the broadcast receiver is turned on/off. The unbound application is permanently or semi-permanently stored in a broadcast receiver. Since the stored application is used, the stored application needs to be periodically updated as time goes by.

The unbound application means a specific unbound application supported by a data broadcasting platform and is simply named the unbound application.

In receiving and storing an application, a method of controlling a storage file system and a configuration of a receiver are explained as follows.

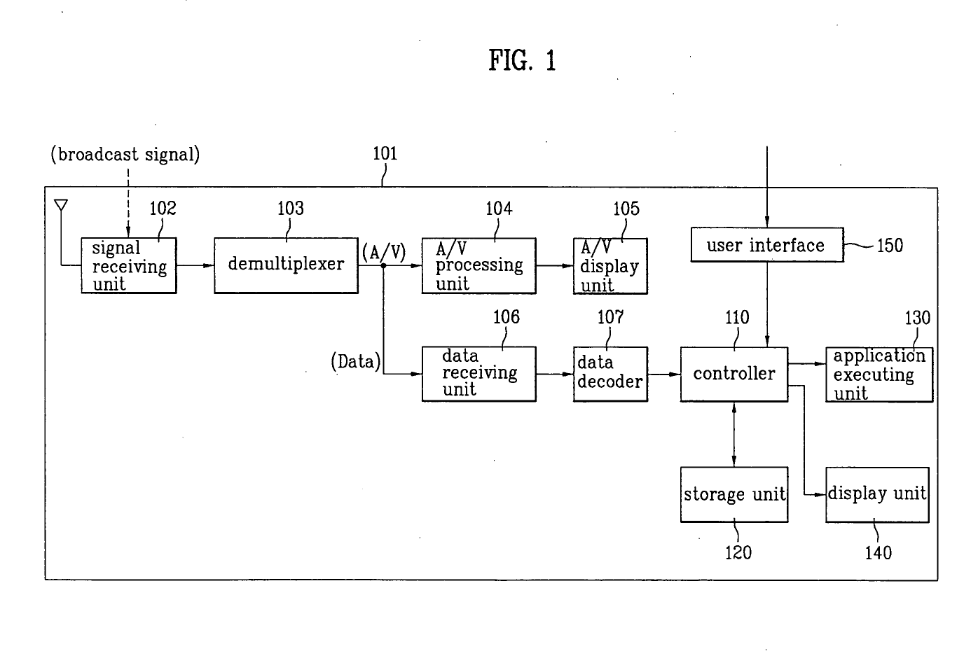

FIG. 1 is a block diagram of a broadcast receiver capable of storing a data broadcast application according to one embodiment of the present invention.

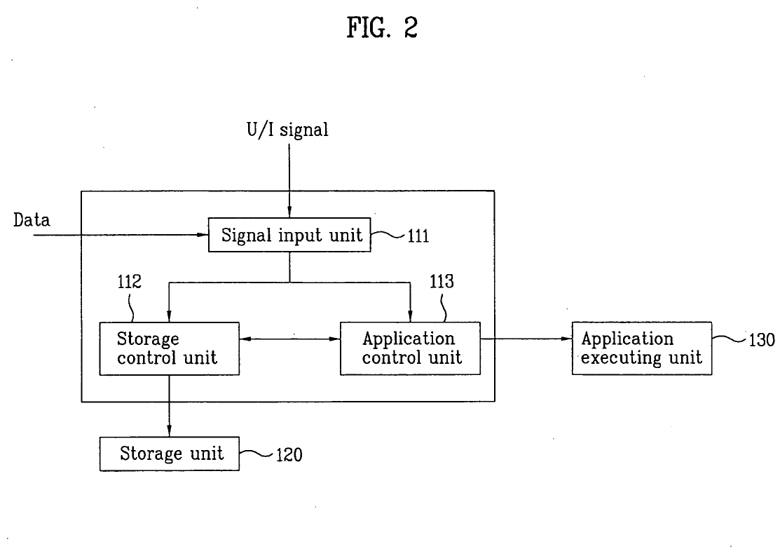

FIG. 2 is a block diagram of a control means of a broadcast receiver for storing a data broadcast application according to the present invention.

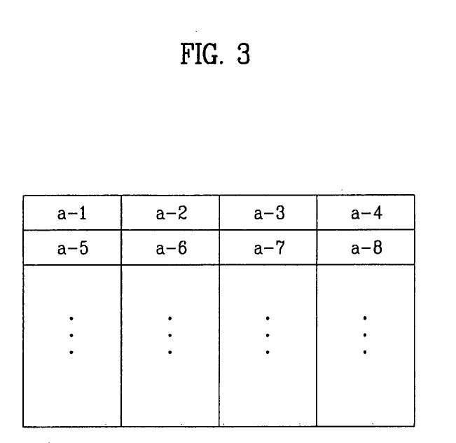

And, FIG. 3 is a diagram to explain a broadcast signal received by being segmented.

An operation of a broadcast receiver according to the present invention to store a data broadcast application is explained with reference to FIGS. 1 to 3 as follows.

First of all, an application of data broadcasting means an application supported by a data broadcasting platform. There are various kinds of data broadcasting such as OCAP (Open Cable Application Platform) data broadcasting, MHP (Multimedia Home Platform) data broadcasting, ACAP (Advanced Common Application Platform) data broadcasting, and the like for example.

An application in the present invention targets an application to be stored. The applications to be stored include an execution management application for managing a whole application and an unbound application known as an application not associated with an A/V stream. The execution management application (or called a monitor application) can be included in the unbound application under the wide category. In the following description, the general application and the execution management application are called an application supported by a data broadcasting platform or a data broadcast application.

Referring to FIG. 1, a broadcast receiver 101 according to the present invention includes a tuner 102, a demultiplexer 103, an A/V processing unit 104, an A/V display unit 105, a data receiving unit 106, a data decoder 107, a controller 110, a storage unit 120, an application executing unit 130, and a display unit 140.

The broadcast receiver 101 may correspond to one of a digital television (DTV) capable of data broadcasting reception, a set-top box, a host of a cable broadcast receiver, and the like. This is just an example and can be generalized into a data broadcast receivable device.

The tuner 102 receives a broadcast signal transmitted by a broadcasting station. In this case, the broadcast signal includes an A/V signal and a data broadcast signal. For instance, the tuner 102 is capable of receiving a cable broadcast signal transmitted by a cable system operator (SO), a multiple system operator (MSO), or the like.

The demultiplexer 103 separates the broadcast signal into the A/V broadcast signal and the data broadcast signal. The demultiplexer 103 then transfers the A/V broadcast signal to the A/V processing unit 104 and also transmits the data broadcast signal to the data receiving unit 106.

The A/V processing unit 104 carries out a process for decoding and the like to enable the received A/V signal to be outputted via the A/V display unit 105.

The A/V display unit 105 then outputs the decoded A/V broadcast signal or the like. In this case, the A/V display unit 105 can include a speaker, a screen of the broadcast receiver, and the like for example.

The data receiving unit 106 performs processing such as header removal and the like on the data broadcast signal transferred from the demultiplexer 103 and then transfers the processed signal to the data decoder 107.

Yet, the data broadcast signal transferred to the data receiving unit 106 is formatted in a manner of being normally segmented into a plurality of data, which are shown in FIG. 3. This is because the broadcasting station or the like is unable to transport a whole file once. Yet, this is just exemplary. Alternatively, whole data can be transferred as well.

The data decoder 107 decodes the data broadcast signal transferred form the data receiving unit 106 and converts the format of a plurality of the segmented data to a single complete file.

The controller 110 controls the storage unit 120, the application executing unit 130, the display unit 140, and the like. In particular, in storing the data broadcast signal transferred from the data decoding unit 107 in the storage unit 120, the controller 110 controls what kind of a storage system will be applied and also controls an execution of an application after the storage system has been switched.

The storage unit 120 stores various applications under the control of the controller 110. The storage unit 120 includes a semi-permanent memory such as a flash memory, a semi-perpetual memory and the like the like instead of a temporary memory. So, the present invention targets the applications stored in the storage unit. For examples, the present invention targets an unbound application independently executed without being associated with an A/V stream and a monitor application for managing an execution of an application.

The application executing unit 130 plays a role in executing various applications under the control of the controller 110. For instance, the applications include data broadcasts associated with games, advertisements, ordering pictures, and the like.

The display unit 140 plays a role in displaying various kinds of information necessary for users under the control of the control unit 108.

For the present invention, the functions or roles of the controller 110, the storage unit 120 and the application executing unit 130 are explained in detail as follows.

First of all, the controller 110 controls storage and execution of an application overall based on a storage system selection signal.

The controller 110, as shown in FIG. 2, includes a signal input unit 111 for receiving a storage system selection signal, a storage control unit 112 controlling the storage unit 130, and an application control unit 130 controlling an execution of an application.

A storage system switching signal transmitted by a headend, which is a party for transmitting a data broadcast, i.e., a broadcasting station or an external input signal of a broadcast receiver is directly inputted to the signal input unit 111. In particular, a subject for deciding whether to switch a storage system can be the headend or a user.

In case that the headend becomes the subject for system switching, the headend may transmit a storage system selection message signal to a broadcast receiver via a communication circuit or a broadcasting station side directly switches an external input by deciding a storage system and then sending a serviceman. This is exemplary and does restrict the scope of the present invention.

In case that a user becomes the subject for system switching, the user is able to select a storage system via an OSD (on screen display) or the like. If this selection switching path is provided to a remote controller or the like, the user is facilitated to select the storage system. These methods are just exemplary. An input of the user selection is performed by a user interface 150.

The storage control unit 112 controls the storage system of the storage unit 120 based on a storage system switching signal. Details of the storage system control are explained as follows.

First of all, the storage system can be categorized into a compression system or a non-compression system. For instance, the compression system is to compress and store a received application. And, the non-compression system is to store a received application intactly. The compression system has an advantageous in association with a storage capacity, while the non-compression system has an advantage in association with an execution time of a system.

If a remaining capacity of the storage unit 120 is in short, the controller 110 selects the compression storage system. Yet, if the remaining capacity is sufficient or if a fast execution of an application is required despite the shortage of the remaining capacity, the non-compression system is used. In case that a signal for this kind of decision is transmitted by the headend, a control unit for receiving the selection signal to decide is necessary for the broadcast receiver. In case that the signal for this decision is an external input of the broadcast receiver, a user interface as a path for the external input and a control unit for deciding it are necessary.

In case that the switching of the storage system is performed, the application control unit 113 controls an execution of the application thereafter. Details of the execution control will be explained in the following description.

In case that the storage system of the storage unit for storing an application is switched to the compression system from the non-compression system, the storage system is formatted and an application supported by a data broadcasting platform is re-downloaded. The system is then initiated again with the re-downloaded application.

Yet, in this case, the storage system can avoid being formatted. In particular, it is able to execute an application by switching the storage system and then downloading the application without formatting the system. By leaving a storage space used so far as it is, it is able to use a rest of the storage space as a compression system. A whole storage space is formatted to use the storage unit. And, a whole storage space including a storage space used so far can be compressed to be used. In this case, a memory space can be more secured.

In case that the storage system for storing an application is switched to the non-compression system from the compression system, the storage system is formatted and an application supported by a data broadcasting platform is re-downloaded. The system is then re-initiated using the re-downloaded application. For this, since a space occupied by a single address is insufficient, the demand for expanding a space occupied by a single address rises overall. So, a whole system formatting is necessary.

Under the control of the controller 110, the storage unit 120 stores a data broadcast application and the application executing unit 130 then executes the application.

A method of controlling a data broadcast application according to the present invention is explained as follows.

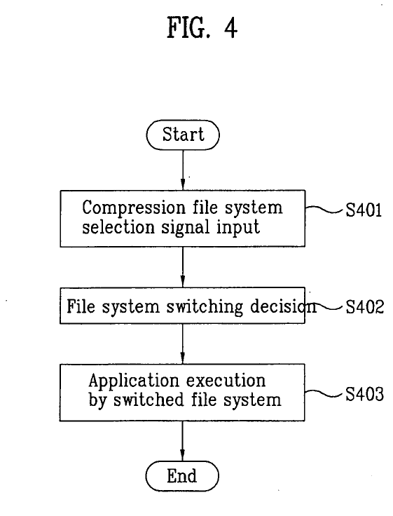

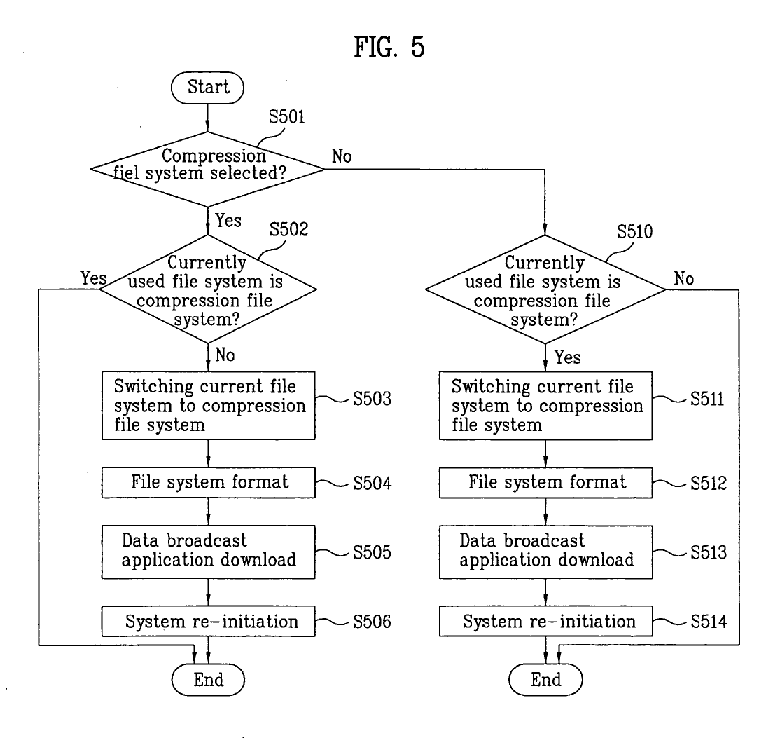

FIG. 4 is a schematic flowchart of a method of controlling a data broadcast application according to the present invention, and FIG. 5 is a detailed flowchart of a method of controlling a data broadcast application according to one embodiment of the present invention.

Referring to FIG. 4 and FIG. 5, a method of controlling a data broadcast application according to the present invention includes the following steps.

First of all, a storage system selection signal is inputted (S401).

A storage system is then decided according to the inputted signal (S402).

Subsequently, an application is executed by the decided storage system (S403).

In the drawing, a file system is described. In the disclosure of the present invention, the file system has the same meaning of the storage system.

If a compression file system is selected (S501), i.e., if a compression file system selection signal is inputted, a currently used file system is estimated. If the currently used file system is the compression file system, it ends without system switching. Yet, if the currently used file system is a non-compression system, the current system is switched to the compression file system (S503). If the system is switched to the compression file system, a file system format is executed (S504). Yet, as mentioned in the foregoing description of the application executing unit of the broadcast receiver, the step s504 can be omitted. Once the file system is formatted, a data broadcast application is downloaded (S505). Subsequently, the system is re-initiated using the downloaded application.

On the other hand, if a non-compression file system is selected (in the drawing, it is represented that the compression file system is not selected) (S501), it is decided whether a currently used file system is the compression file system or not (S510). If the currently used file system is not the compression file system, i.e., if the non-compression file system is used, it ends without system switching. Yet, if the currently used file system is the compression system, the current system is switched to the non-compression file system (S511). If the system is switched to the non-compression file system, a file system format is executed (S512). Once the file system is formatted, a data broadcast application is downloaded (S513). Subsequently, the system is re-initiated using the downloaded application (S514).

The description of the broadcast receiver for storing the data broadcast application is applicable to the present method.

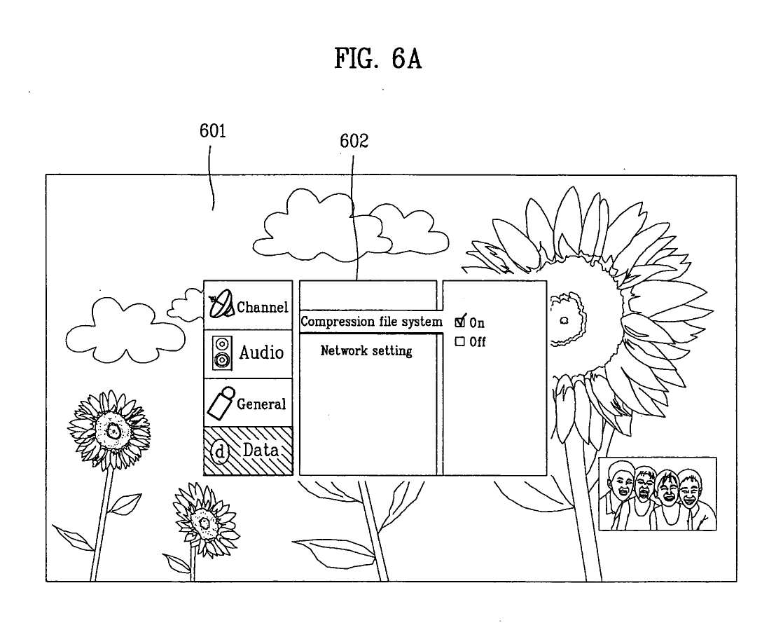

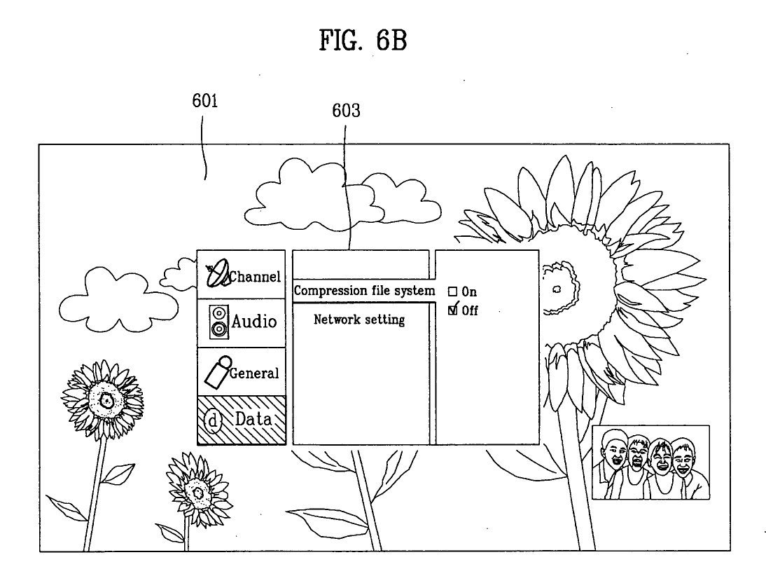

FIG. 6A and FIG. 6B are diagrams of OSD for enabling external inputs.

Referring to FIG. 6A and FIG. 6B, it is facilitated to select whether to use a compression file system using OSD.

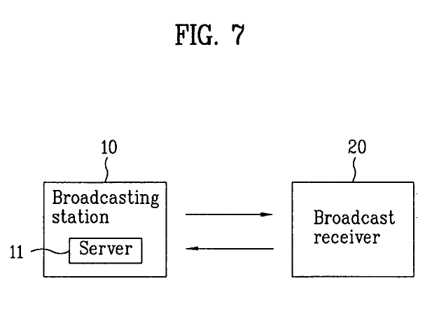

FIG. 7 is a block diagram of a whole broadcast system according to the present invention.

Referring to FIG. 7, a broadcast system according to the present invention includes a broadcasting station 10 and a broadcast receiver 20. The broadcasting station 10 includes a server 11. The broadcast system is to explain a case that a selection of a storage system is made by a headend for example.

The broadcasting station 11 transmits data associated with a storage system to the broadcast receiver 20. In this case, the data is stored in the server 11 of the broadcasting station 10. The data stored in the server of the base station can be transmitted via one of Internet, LA/V, cable, TCPIP, and the like.

In this case, application associated information stored in the server 11 is transmitted by data transmitting scheme such as carousel and the like. The carousel means a method of repeatedly transmitting data to effectively use a downlink channel having a bandwidth relatively greater than that of an uplink channel in digital video broadcasting. The carousel is exemplarily proposed and does not restrict the scope of embodiment of the present invention.

Accordingly, the present invention provides the following effects or advantages.

First of all, hardware can be expanded without additional cost using a compression storage system to store a data broadcast application in a memory.

Secondly, a storage system can be switched to a non-compression system to execute an application faster using a compression storage system in case that a speed is reduced.

Hence, a storage system is selectable according to a size and use policy of an application.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A broadcast receiver comprising:
a signal receiving unit receiving a data broadcast signal including an application supported by a data broadcasting platform;
a data decoder decoding the data broadcast signal;
a storage unit for storing the application decoded by the data decoder; and
a control means for controlling a storage system of the storage unit according to a signal for selecting the storage system of the storage unit, the control means controlling an execution of the application.

2. The broadcast receiver of claim 1, wherein the storage system of the storage unit comprises either a compression file system or a non-compression file system.

3. The broadcast receiver of claim 1, wherein the signal for selecting the storage system of the storage unit is sent by a party transmitting a broadcast.

4. The broadcast receiver of claim 1, wherein the signal for selecting the storage system of the storage unit is an external input signal by a user.

5. The broadcast receiver of claim 1, further comprising an interface unit for receiving an external input signal for selecting the storage system of the storage unit, the interface unit sending the received signal to the control means.

6. The broadcast receiver of claim 1, wherein the application supported by the data broadcasting platform to be stored in the storage unit comprises an unbound application.

7. The broadcast receiver of claim 1, further comprising an application executing unit re-initiating the system, if the storage file system is switched, by formatting a previous file system and downloading a data broadcast application.

8. The broadcast receiver of claim 1, the control means comprising:
a signal input unit receiving a storage system selection signal;
a storage unit control unit controlling the storage unit according to the received signal; and
an application control unit controlling the execution of the application if the storage system is switched.

9. The broadcast receiver of claim 8, wherein the signal input unit received either a storage system switching signal transmitted from a broadcasting station or an external input.

10. A method of controlling a data broadcast application, comprising:
receiving a storage system selection signal;
switching a storage system according to the storage system selection signal; and
storing a received application supported by a data broadcasting platform by the switched storage system.

11. The method of claim 10, wherein the storage system selection signal is decided by a party for transmitting a data broadcast.

12. The method of claim 10, wherein the storage system selection signal is received via a broadcast communication circuit.

13. The method of claim 10, wherein the storage system selection signal is inputted via an external input port of a broadcast receiver.

14. The method of claim 10, wherein the storage system comprises a compression storage system or a non-compressions storage system.

15. The method of claim 10, wherein the switching of the storage system is executed if a current storage system differs from an inputted storage system.

16. The method of claim 10, wherein the storing comprises the steps of:
formatting the storage system; and
downloading the data broadcast application from the switched storage system.
